(19) United States
(12) Patent Application Publication
(10) Pub. No.: US 2016/0112287 A1
(43) Pub. Date: Apr. 21, 2016

(54) STORING AND ANALYZING NETWORK TRAFFIC DATA

(71) Applicant: WildPackets, Inc., Walnut Creek, CA (US)

(72) Inventors: Dan Farmer, Seattle, WA (US); Thomas E. Rowley, San Jose, CA (US); Mark Andrews, Pleasant Hill, CA (US)

(21) Appl. No.: 14/689,456

(22) Filed: Apr. 17, 2015

Related U.S. Application Data
(60) Provisional application No. 62/064,582, filed on Oct. 16, 2014.

(51) Int. Cl. H04L 12/26

(52) U.S. Cl. CPC H04L 43/08; H04L 43/04

(57) ABSTRACT

An improved mechanism is provided for storage, recovery, and analysis of network traffic data, without requiring prohibitive amounts of storage space. Network traffic data is recorded in a sliding buffer. In normal operation, after some period of time, the oldest data in the buffer is deleted, yielding more storage space for more recent data. In response to a trigger event, such as any detected problem, attack, or similar incident, relevant pre-event and post-event data is retained for analysis.

### CROSS-REFERENCE TO RELATED APPLICATIONS

The present application claims priority from U.S. Provisional Application No. 62/064,582 for “Means for Enabling Long-Term Network Storage and Analytics while Dramatically Reducing Required Storage Space,” filed Oct. 16, 2014, the disclosure of which is incorporated herein by reference.

### FIELD

The present disclosure relates to storage and analysis of traffic data for electronic networks.

### DESCRIPTION OF THE RELATED ART

It is often useful, when troubleshooting, analyzing, debugging, or investigating a computer network, to have access to captured or stored data that describes network traffic. By analyzing such stored data, a network expert or automated system can review the history of network transactions and communications that have taken place, and thus be in a position to diagnose problems (including deliberate attacks as well as system malfunctions) and take appropriate action.

Current electronic communications networks, such as the Internet, often use packet-switched communications protocols. According to such protocols, information is broken up into discrete collections of bits, referred to as packets, which are then transferred from source to destination. Packets may be organized into headers and payload: the header includes metadata, or information about the packet itself, such as the size of the packet, its source and destination, and the like; and the payload includes the data being conveyed. Stored data describing both headers and payload may be of critical importance in analyzing, discovering, and understanding system problems. For example, such information can be very useful when analyzing how an attacker may have penetrated a network as well as tracing his or her activities inside the network.

To facilitate such investigations and analyses, therefore, it is useful to capture packets associated with a particular event, stream of data, communication, set of communications, or attack. Existing systems often use a passive monitoring device, such as a network analyzer, packet recorder, or protocol analyzer, to capture packets traversing the network for later investigation and/or analysis.

One problem with such an approach is that, as network traffic increases (due to increases in size and speed of computer networks), storage of packet data becomes prohibitive. Accordingly, it has become increasingly difficult to capture, store, retrieve, and analyze all packets that may potentially be useful in analyzing system problems. For example, even a small business with a few dozen employees and their associated computers could easily generate traffic approaching or exceeding ten megabytes of data per second; such traffic would necessitate the collection and storage of a terabyte of data per day representing external network traffic, plus additional space needed for internal Intranet network traffic. Therefore, it rapidly becomes unfeasible to store all packet data for possible future analysis.

Intrusion detection systems (IDS's) are commonly used for monitoring network and/or system activities for malicious activities or policy violations, generating alerts when problems are detected, and producing reports that can help in analyzing and addressing such attacks and/or activities. In many cases, such IDS's produce a large number of false positives; as a result, serious attacks are often overlooked because they are buried in a large volume of false alerts or less serious attacks. In fact, many current techniques used for attack discovery frequently do not reveal that an attack has taken place until an extended time has elapsed, i.e., some weeks, months, or even a year or more after the incident took place. It can often be unfeasible to store all network traffic data for a long enough period that allows for such late detection of an incident. Hence, once a problem or incident has been identified, it is often the case that the relevant packet data is lost because it may have been deleted or is otherwise unavailable.

### SUMMARY

According to various embodiments, an improved mechanism is provided for storage, recovery, and analysis of network traffic data. The techniques described herein facilitate storage and retrieval of relevant information over extended periods of time, without requiring prohibitive amounts of storage space.

In at least one embodiment, the system described herein allows for recovery and analysis of packet information long after an event, incident or attack has taken place. Such information can then be used to reconstruct the event, as well as perform recovery and analysis operations.

In at least one embodiment, the system stores network traffic data, such as packet headers and/or payload, related to a trigger event (such as a security breach, attack, or other issue), for a period of time before and after the event. In at least one embodiment, the system processes such traffic data through application identification software and stores, in a database, all application flow details for the entire network, or a selected portion of such information deemed to be of significance to the detected trigger event.

In at least one embodiment, the system takes advantage of the fact that not all of the information that traverses the network during the event is needed in order to recreate and analyze the major details of the event. Accordingly, the system keeps a buffer of the most recent network traffic data (such as packets) in memory; then, when an event is detected, the system selectively retains and stores network traffic data from the buffer that may be related to the event.

In this way, the system may selectively and programmatically save data describing relevant network traffic both prior to and after an event. By selectively retaining some network traffic data while discarding other information, the system is able to conserve storage space. The retained network traffic data can be indexed or optimized for retrieval and analysis at a later date.

In at least one embodiment, the system captures and records network traffic data in a sliding buffer, which can be in local data storage or memory. Thus, at any given time, network traffic data for some period of time is available in the buffer. In normal operation, after some period of time, the oldest data in the buffer drops off and is deleted, yielding more storage space for more recent data.

In response to a trigger event, which can be can be any detected problem, attack, or similar incident, the system retains some or all of the data in the sliding buffer, representing network traffic for some period of time prior to the event. In addition, the event is added to an active events list, so that additional data representing post-event network traffic will be retained as well. After some predefined period of time, the event is removed from the active events list. In this manner, in response to detection of an event, the system ensures that relevant network traffic data will be available for analysis, including data describing network traffic both before and after the event.

Any suitable technique can be used to detect trigger events. For example, in at least one embodiment, the system can use signals or events from any available software or hardware tools that are adapted to detecting incidents, problems, and attacks. Such tools may include, for example, IDS's, trouble tickets, alarms, and the like. Any of these components can generate triggers that initiate traffic data retention and sequester.

Data retained in response to a trigger event can be kept indefinitely, or can be stored for some period of time so as to allow for analysis to take place. Alternatively, such data can be manually deleted once it is determined that the data is no longer needed (for example, after analysis has determined that the trigger event was a false positive).

In some cases, the trigger event signal provides additional information as to which data should be retained. For example, if the trigger event signal identifies specific source and destination addresses of potential interest, then the system can be configured to selectively retain network traffic data that relates to the specifically identified source and destination addresses, for some defined period before and after the trigger, including both packet metadata as well as packet payload. In at least one embodiment, the system can also be configured to retain additional data that may be useful for analysis, such as packet metadata and payload for other connections that were made by the source and destination IP addresses, for a period before and after the trigger event. In at least one embodiment, the system does not attempt to discriminate between real and false positive signals, but rather collects all related packets for any signal. This data may be kept in a database for lookup or in any number of raw or less-structured formats (e.g. “pcap”, snoop, ngsniffer, and/or the like.)

In at least one embodiment, in addition to retaining data for particular network nodes associated with an event, the system can also be configured to collect, for a configurable period of time before and after a trigger event, all of the packets for all of the nodes in the network of interest. This additional step can be performed for any suitable period of time before and after a trigger event, which may be designated a “critical” retention period. The critical retention period can be specified for collection of all network traffic data for a network, in addition to an ordinary retention period during which only that network traffic data associated with a particular node may be retained. Both the critical retention period and the ordinary retention period can include pre-event and post-event time periods. Normally, the critical retention period is shorter than the ordinary retention period, although this need not be the case.

By saving traffic data for network traffic that takes place both before and after the trigger event, either selectively or network-wide, for some period of time, the system provides useful information about what took place before and after the event, thus granting greater context and clarity.

In at least one embodiment, network traffic that is not retained can be deleted. Alternatively, such data can be partially saved, aggregated, summarized, or otherwise processed. For example, parts of the packets, or data derived from the packets, can be saved, and the rest of the data can be deleted. In at least one embodiment, packet headers can be saved, while the packet payload is discarded. In another embodiment, some of the metadata can be retained (such as the origin and/or destination of the packet), and/or some of the payload can be retained (such as strings or interesting data). In at least one embodiment, results of aggregation, summarization, or analytics performed on the traffic data can be retained (for example, a combination of examining the network port, protocol, and payload might indicate that the packets are part of an Oracle database session, which information can be encoded and saved). In some cases, packets that correspond to a triggering event are far less frequent than the overall network traffic, so that significant storage space savings may be gained over systems that save all raw packets, while still retaining the metadata required to do meaningful analysis without the full packet payload.

Further details and variations are described herein.

### BRIEF DESCRIPTION OF THE DRAWINGS

The accompanying drawings illustrate several embodiments. Together with the description, they serve to explain the principles of the system and method according to the embodiments. One skilled in the art will recognize that the particular embodiments illustrated in the drawings are merely exemplary, and are not intended to limit scope.

FIG. 1 is a block diagram depicting a hardware architecture for storing and analyzing network traffic data according to one embodiment.

FIG. 2A is a flow diagram depicting a method for tracking events according to one embodiment.

FIG. 2B is a flow diagram depicting a method for buffering and selectively retaining network traffic data according to one embodiment.

FIG. 3 is an example of operation of a sliding buffer for storing recent network traffic data, according to one embodiment.

FIG. 4 is an example of selectively retaining data from a sliding buffer in response to a trigger event, according to one embodiment.

FIG. 5 is an example of an embodiment in which two sets of retention periods are established, including an ordinary retention period and a critical retention period during which data relating to all network nodes is retained in response to a trigger event, according to one embodiment.

FIG. 6 is a block diagram depicting a scenario in which it is beneficial to store network traffic data for system components other than those directly targeted by an incoming attack, according to one embodiment.

### DETAILED DESCRIPTION OF THE EMBODIMENTS

### Definitions

The following terms are defined for purposes of the description provided herein:
Packet: A unit of data being routed from an origin to a destination on an electronic network, for example via the Internet Protocol (IP) or other suitable protocol.
Header: the portion of a packet that contains addressing and other data that is required for it to reach its intended destination.
Metadata: information about a packet, such as the size of the packet, its source and destination, and the like; typically included in the header of the packet.
Payload: the data being carried within the packet, other than the header.
Network traffic data: data (including packets) being transmitted across an electronic network.
Time stamp: a specific time and/or date associated with an item of network traffic data, most commonly associated with the time and/or date at which the data item was transmitted, received, recorded, or detected.
Relevant network traffic data: network traffic data that is deemed to be potentially useful in investigating, analyzing, or otherwise considering actions performed via the network, problems with the network, or data transmitted via the network. Relevance is described in more detail below.
Trigger event: An attack, breach, problem, outage, or other incident that indicates a possible need to retain relevant network traffic data for future investigation or analysis.
Active event list: A list of recent trigger events for which network traffic data is to be retained.
Active trigger event: A trigger event currently listed on the active event list.
Retention period: A time period before and/or after a trigger event; at least some data items having a time stamp within the retention period are retained for future analysis. In at least one embodiment, the retention period can include a pre-event retention period (before the trigger event) and a post-event retention period (after the trigger event). In at least one embodiment, at least two retention periods can be specified, including a critical retention period and an ordinary retention period.
Critical retention period: A time period before and/or after a trigger event; in at least one embodiment, all data items having a time stamp within the critical retention period are retained for future analysis.
Ordinary retention period: A time period before and/or after a trigger event; in at least one embodiment, data items deemed relevant to the trigger event and having a time stamp within the ordinary retention period are retained for future analysis.
Sliding buffer: An area of memory or data storage for temporary storage of network traffic data.
Expiration period: The time period for which data is temporarily stored in the sliding buffer. In at least one embodiment, this is equal to or greater than the pre-event retention period.
Expiration time: The end of the expiration period for a particular buffered data item.
Intrusion detection system (IDS): Any component or system configured to detect an attack, breach, problem, outage, or other incident that has taken place with respect to an electronic network.
Network data traffic monitor: Any component or system configured to monitor, track, and/or record network traffic data on an electronic network. This data may be referred to as raw data.
Network analysis device: Any component or system configured to analyze an electronic network, including analysis of incidents occurring on such network.

According to various embodiments, the system and method described herein can be implemented in any context where it is beneficial to retain selected information in response to a trigger event, and in particular to retain selected information that was recorded or captured before the trigger event took place. As described in more detail below, in many such contexts, data is continuously recorded or captured, and subsequently selectively retained or deleted (or otherwise processed), depending on whether a trigger event was detected. In response to the trigger event, data captured before and/or after the trigger event can be retained for future consumption, analysis, and/or other processing. A retention policy can be applied to retained data, so that it too is deleted after some period of time, after consumption, when it is determined that space is needed, and/or after some other defined event.

Although the system is described herein in connection with an implementation in a system for analyzing network traffic issues, problems, attacks, and the like, one skilled in the art will recognize that the techniques described herein can be implemented in other contexts, and indeed in any context where it is beneficial to retain selected information in response to a trigger event. Although some examples of these other contexts are described below, such descriptions are not intended to be limiting. Accordingly, the following description is intended to illustrate various embodiments by way of example, rather than to limit scope.

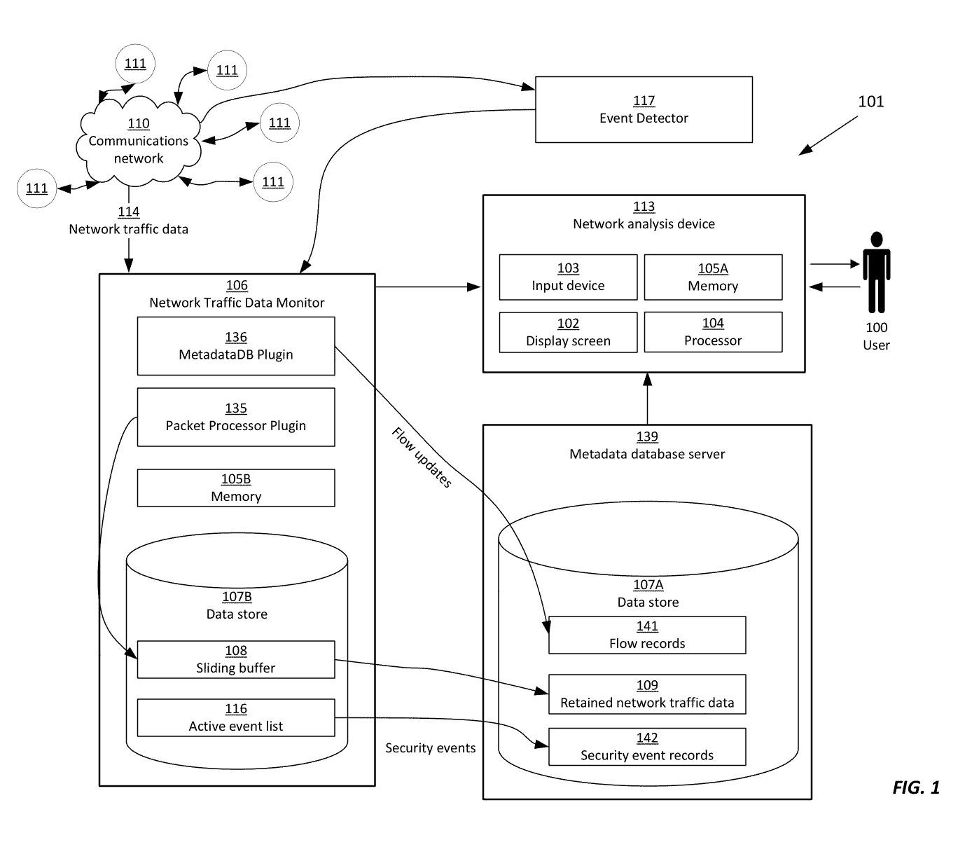

Referring now to FIG. 1, there is shown a block diagram depicting a hardware architecture for storing and analyzing network traffic data according to one embodiment. Such an architecture can be used, for example, for implementing the techniques described herein in a system 101 including a number of computing devices or other electronic devices, configured to receive data from a communications network 110 such as the Internet.

In at least one embodiment, system 101 includes a number of hardware components that can be implemented separately or in combination with one another. Thus, although FIG. 1 depicts separate components such as event detector 117, network traffic data monitor 106, metadata database server 139, and network analysis device 113, one skilled in the art will recognize that any or all of such components can be implemented in a single device or across any number of devices that communicate with one another via any electronic communications network or other mechanism. Thus, the functionality described herein can be implemented in a distributed, integrated, or network-based environment.

### Network Traffic Data Monitor 106

Network traffic data monitor 106 monitors communications that take place among nodes 111 on communications network 110. Communications network 110 can be any type of electronic network, such as for example the Internet, an Intranet, or any other network, such as for example, a cellular telephone network, EDGE, 3G, 4G, long term evolution (LTE), Session Initiation Protocol (SIP), Short Message Peer-to-Peer protocol (SMPP), SS7, Wi-Fi, Bluetooth, ZigBee, Ethernet, or any other wired and/or wireless network. Communications can take place using any known protocol, such as for example packet-switched communications using Hypertext Transfer Protocol (HTTP), Secure Hypertext Transfer Protocol (SHTTP), Transmission Control Protocol/Internet Protocol (TCP/IP), and/or the like, and/or any combination thereof. Monitor 106 can be implemented as any known component for monitoring and capturing network traffic data 114 from network 110.

In at least one embodiment, network traffic data 114 captured by monitor 106 contains a number of packets; each packet is processed through two plugins: metadataDB plugin 136 and packet processor plugin 135.

MetadataDB plugin 136 maintains a map of conversations taking place on network 110, including information such as which nodes 111 are acting as hosts and/or destinations for the various conversations, and/or which applications are currently running. When a new packet is captured by monitor 106 as part of network traffic data 114, plugin 136 determines if the packet belongs to an existing conversation, in which case it maps the packet to the conversation; if the packet does not belong to an existing conversation, plugin 136 generates a record for a new conversation, and maps the packet to the new conversation. Periodically, plugin 136 sends flow updates to data store 107A of metadata database server 139, including information describing mappings between conversations and packets; this information is shown in FIG. 1 as flow records 141.

Packet processor plugin 135 stores each captured packet in sliding buffer 108, as described in more detail below. Sliding buffer 108 may be maintained in data store 107B of monitor 106, or in memory 105B. Sliding buffer 108 is used for temporary storage of network traffic data 114, according to techniques described below. In at least one embodiment, at any given time, sliding buffer 108 contains (at most) the most recently captured network traffic data 114 up to a pre-defined time period; for example, sliding buffer 108 might contain the most recent 10 minutes (or some other duration) of network traffic data 114. As new network traffic data 114 is captured, old network traffic data 114 is deleted or otherwise processed (unless it is tagged for retention in response to a trigger event, as described below). In this manner, network traffic data 114 (such as packet headers and/or payload) is recorded for some period before and after a detected trigger event, specified as a retention period.

In at least one embodiment, any network traffic data older than the pre-specified period of time is filtered to determine whether either the source or destination IP address of the packet is found in any trigger event currently in active event list 116. If no match is found, the packet is deleted (or otherwise processed, as described below). If a match is found, the packet (and/or other network traffic data) is retained. In at least one embodiment, retained network traffic data 109 (i.e., packet data) is stored in data store 107A of metadata database server 139. Packet processor plug-in 135 can use any suitable mechanism for sending data to server 139, such as for example open database connectivity (ODBC).

In at least one embodiment, data store 107B also stores active event list 116, which is a list of all trigger events for which data is currently being retained. In at least one embodiment, events are added to active event list 116 when detected by event detector 117. For example, monitor 106 may receive updates (such as syslog updates) from event detector 117, and can maintain active event list 116 based on such information. Active event list 116 may be maintained in data store 107B of monitor 106, or in memory 105B, or elsewhere. As described in more detail below, events in active event list 116 can represent problems, attacks, intrusion, malfunctions, and/or the like, taking place with respect to network 110.

In at least one embodiment, events in active event list 116 expire after some period of time. Thus, when network traffic data monitor 106 is notified of a trigger event, the event is added to active event list 116; some period of time later, as specified by the retention period, the event is removed from active event list 116.

In at least one embodiment, some or all events are stored after they are no longer active. For example, when events are being removed from active event list 116, they can be sent to metadata database server 139, to be stored as security event records 142 in data store 107A. In this manner, historical event data is made be available for future analysis in connection with retained network traffic data 109 and/or flow records 141.

### Metadata Database Server 139

Metadata database server 139 contains data store 107A for storing various data to be used by network analysis device 113 in performing forensic analysis of network events. Such data can include flow records 141, based on flow updates received from plugin 136; retained network traffic data 109, including packet data from sliding buffer 108 that has been tagged for retention and further analysis; and security event records 142, describing events that triggered retention of network traffic data 109. Any or all of such data can be used by network traffic analysis device 113 in performing analysis of network problems, issues, and attacks, according to techniques described below.

### Event Detector 117

Event detector 117 detects events that occur with respect to communications network 110. In at least one embodiment, event detector 117 can be implemented as, for example, an intrusion detection system (IDS) running Snort, Suricata, or the like, or any other suitable system for monitoring network 110 and generating alerts when problems or issues arise. Event detector 117 can be configured to forward trigger events, security events, and/or other detected issues or problems to network traffic data monitor 106, via a log processing system such as rsyslog. Network traffic data monitor 106 receives the rsyslog updates, and stores and processes events logged in such updates, to maintain active event list 116. Event detector 117 can be implemented as part of monitor 106, or it can be a separate component, which may be remote or local with respect to other components of system 101.

### Network Analysis Device 113

Network analysis device 113 performs network analysis functions, based on data received from network traffic data monitor 106 and/or metadata database server 139. Analysis can therefore be performed on any or all of flow records 141 (representing conversations and interactions among nodes), retained network traffic data 109 (representing stored packets), and/or security event records 142 (representing events that triggered retention of packets). Network analysis device 113 can be any electronic device incorporating an input device 103 and/or display screen 102, such as a desktop computer, laptop computer, personal digital assistant (PDA), cellular telephone, smartphone, music player, handheld computer, tablet computer, kiosk, game system, or the like. In at least one embodiment, device 113 can be implemented using any suitable software for displaying network traffic analysis, such as for example a security information and event management (SIEM) software application such as Splunk (available from Splunk Inc. of San Francisco, Calif.), or the OmniPeek Network Analyzer (available from WildPackets, Inc. of Walnut Creek, Calif.).

Display screen 102 can be any element that displays information, which can include, for example, alerts, data, reports and the like, and in particular can display information concerning network traffic issues, concerns, and attacks. Input device 103 can be any element that receives input from user 100, such as for example a touchscreen, keyboard, mouse, dial, wheel, button, trackball, stylus, or the like, or any combination thereof. Input device 103 can also receive speech input or any other form of input. Processor 104 can be a conventional microprocessor for performing operations on data under the direction of software, according to well-known techniques. Memory 105A can be random-access memory, having a structure and architecture as are known in the art, for use by processor 104 in the course of running software.

Any suitable type of communications network, such as the Internet, can be used as the mechanism for transmitting data among the components of system 101. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, device 113, monitor 106, server 139, and/or event detector 117 can each include a network communications interface (not shown) or other suitable component for enabling communication with other components via an electronic network.

Data stores 107A, 107B can be any magnetic, optical, or electronic storage device for data in digital form; examples include flash memory, magnetic hard drive, CD-ROM, or the like. Data stores 107A, 107B can be local or remote with respect to the other components of system 101. Data can be stored in data stores 107A, 107B using any suitable format or structure, such as for example in a database format. In an alternative embodiment, any or all of active event list 116, sliding buffer 108, and/or retained network traffic data 109 can be stored in memory rather than in data stores 107A, 107B. Alternatively, any or all of these can be stored in separate data stores and need not be stored in the particular data stores 107A, 107B depicted in FIG. 1. In at least one embodiment, data stored in data stores 107A, 107B may be organized into one or more well-ordered data sets, with one or more data entries in each set. Data stores 107A, 107B can, however, have any suitable structure.

System 101 can be implemented in standalone environment, or in a distributed or client/server environment, or according to any other suitable architecture. An example of a client/server environment is an Internet-based implementation, wherein the various components of system 101 can be located remotely with respect to one another. For example, device 113 can run a browser or app that provides a user interface for interacting with server 139 and monitor 106, and that performs analysis on retained network traffic data 109 stored in server-based data store 107A. Interactions between user 100 and the various components of the system can take place via the browser or app, for example by presenting interactive web pages for presenting information to user 100 and receiving input from user 100. Reports, graphs, status updates, alerts, notifications, and/or the like, based on network traffic analysis, can be presented as part of such web pages and/or apps, using known protocols and languages such as Hypertext Markup Language (HTML), Java, JavaScript, and the like.

In one embodiment, various components of system 101 can be implemented as software written in any suitable computer programming language, whether in a standalone or client/server architecture. Alternatively, they may be implemented and/or embedded in hardware.

Various components described above perform various functions within the overall system. Some of the functions performed by these components include, for example:
Event Processing: Event processing includes periodically polling the system log for new trigger events, and parsing the formats of various IDS/SEIM components into a canonical representation. In at least one embodiment, such tasks are performed by monitor 106, by polling Suricata messages from a system log file generated using data from event detector 117 such as a Suricata IDS. A page is displayed, showing trigger events such as security intrusions; as descried herein, network traffic data for a specified period before and after each event is stored, if the source or destination IP address is flagged in the trigger event.
Packet Processing: Packet processing includes buffering network traffic data in sliding buffer 108 and reading the log of events. In at least one embodiment, this is performed by plugin 135 of network traffic data monitor 106, with data stored in data store 107B and/or in memory 105B.

### Method

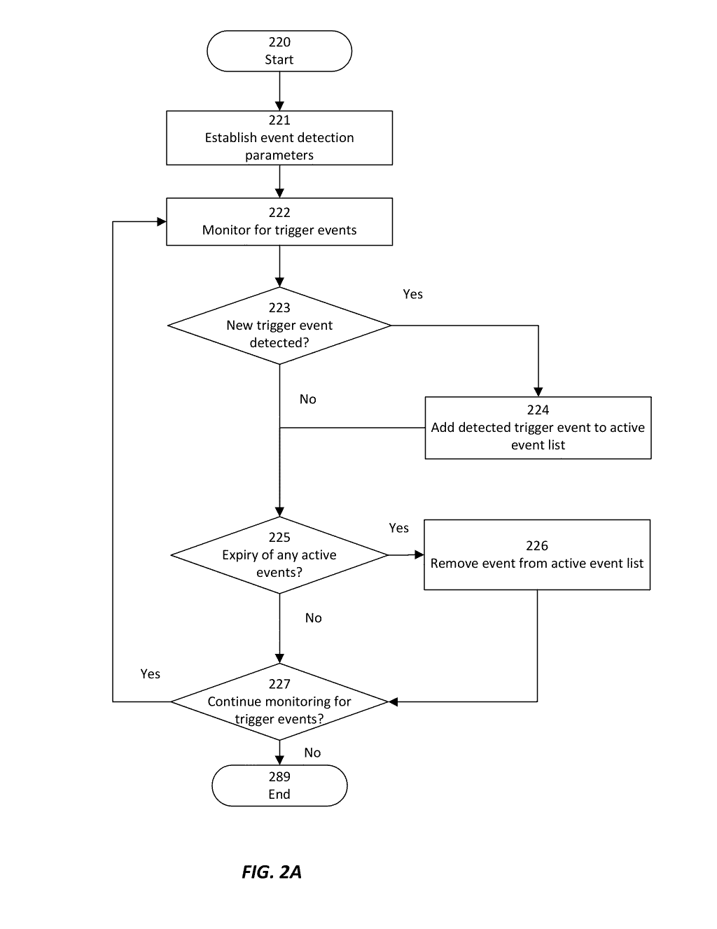

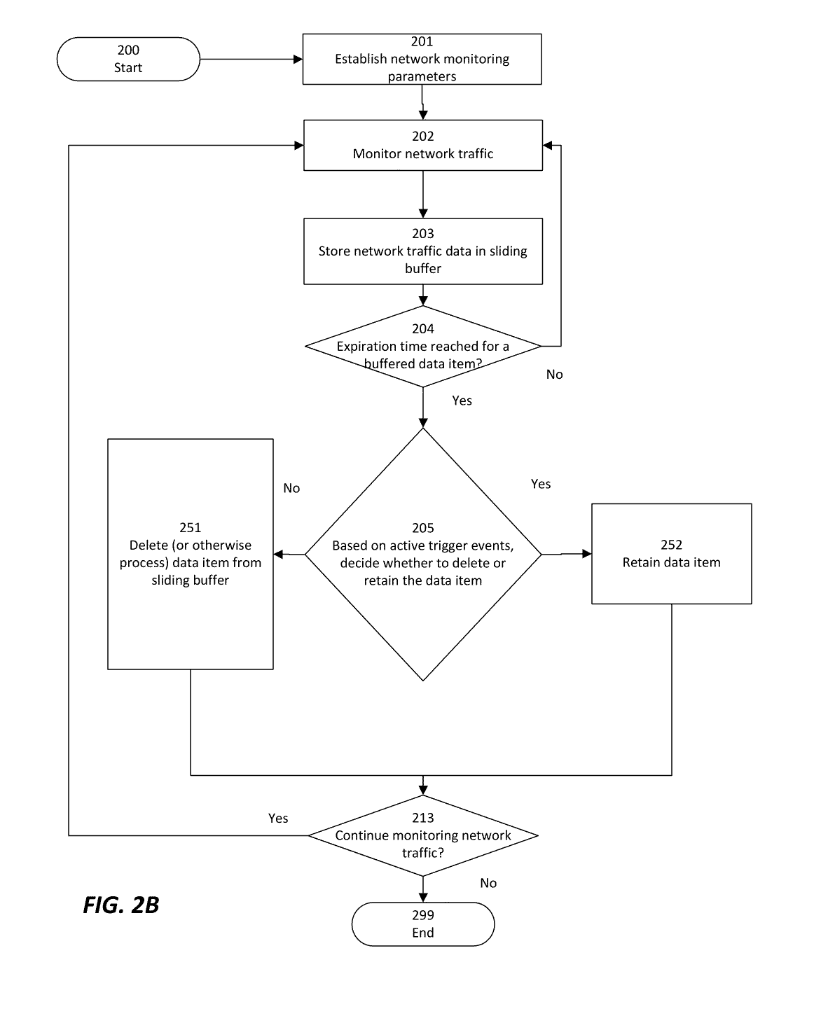

Referring now to FIG. 2A, there is shown a flow diagram depicting a method for tracking events according to one embodiment. The method depicted in FIG. 2A can be implemented using any suitable architecture, including for example that depicted in FIG. 1. In at least one embodiment, the method is implemented by event detector 117, which detects events that take place with respect to network 110, and maintains active event list 116 as described herein.

The method begins 220. Any suitable parameters 221 are established for detecting events. Such parameters can specify, for example, that certain types of detected network traffic should be considered trigger events because they are likely to be attacks, intrusions, malfunctions, or other problems. In addition, step 221 can include establishment of an event expiration time period, during which events should be maintained in active event list 116.

Event detector 117 then monitors 222 for trigger events. In at least one embodiment, this includes receiving trigger events such as security events from an intrusion detection system (IDS) and/or security information and event management (SIEM) software. When a new trigger event is detected 223, such as an intrusion or network problem, it is added 224 to active event list 116. A timer can be set, so that the trigger event stays on active event list 116 for a particular length of time (corresponding to the retention period) and is then removed from list 116.

When a trigger event is detected 223, it is added 224 to active event list 116. After some time period (for example, a time period corresponding to the retention period), active events expire. When an active event expires 225 it is removed 226 from active event list 116.

If further monitoring is desired 227, event detector 117 returns to step 222. Otherwise, the method ends 289.

Referring now to FIG. 2B, there is shown a flow diagram depicting a method for buffering and selectively retaining network traffic data 114 according to one embodiment. The method depicted in FIG. 2B can be implemented using any suitable architecture, including for example that depicted in FIG. 1. In at least one embodiment, the method is implemented by network traffic data monitor 106, which monitors traffic on network 110 and records traffic data 114 in sliding buffer 108, as described herein.

In at least one embodiment, the method of FIG. 2B takes place concurrently with that of FIG. 2A. Thus, while event detector 117 is monitoring for trigger events and active event list 116 is being managed as depicted in FIG. 2A, network traffic data monitor 106 is monitoring network traffic data 114, and such data is being buffered and selectively retained based on which events are currently in active event list 116, as depicted in FIG. 2B.

The system establishes 201 network monitoring parameters. For example, such parameters can indicate the type of network traffic data 114 that should be captured. Parameters can be established 201 based on manual configuration, automated configuration, default values, or the like. In at least one embodiment, parameters include retention parameters for retaining network traffic data 114 in response to trigger events. For example, a pre-event retention period and post-event retention period can be established, to specify what duration of network traffic data should be retained in response to a trigger event as follows:
The pre-event retention period specifies the time period before each event, for which network traffic data 114 should be retained;
The post-event retention period specifies the time period after each event, for which network traffic data 114 should be retained.

Once the network monitoring parameters have been established 201, network traffic data monitor 106 monitors 202 network traffic based on the established parameters. Network traffic data monitor 106 stores 203, or buffers, network traffic data 114 in sliding buffer 108. In at least one embodiment, each data item in network traffic data 114 has a time stamp, which identifies a specific time and/or date associated with the data item, most commonly associated with the time and/or date at which the data item was recorded or detected. Sliding buffer 108 is configured to retain each item of network traffic data 114 for some pre-defined period of time after the time stamp; this time period is referred to as an expiration period.

If an expiration time is reached 204 for a buffered data item, a decision is made 205 as to whether to retain, delete, or otherwise process the data item. In at least one embodiment, decision 205 is made based on whether any active trigger events have a retention period that includes the time of the expiring data item's time stamp.

Specifically, in at least one embodiment, if any active trigger events have a retention period that includes the time of the expiring data item's time stamp, the data item is retained 252, for example by copying or transferring it to a data store for future analysis, such as server-based data store 107A of server 139.

In another embodiment, if any active trigger events have a retention period that includes the time of the expiring data item's time stamp, a determination is made as to whether the data item is relevant to the active trigger event. If it is relevant, the data item is retained 252.

In yet another embodiment, two retention periods can be specified: an ordinary retention period and a critical retention period. If any active trigger events have a critical retention period that includes the time of the expiring data item's time stamp, the data item is retained 252. Otherwise, if any active trigger events have an ordinary retention period that includes the time of the expiring data item's time stamp, a determination is made as to whether the data item is relevant to the active trigger event. If it is relevant, the data item is retained 252.

One skilled in the art will recognize that other mechanisms and methodologies can be applied, in determining 205 whether or not to retain a data item.

Any suitable criteria can be used to determine relevance of an expiring data item to the trigger event. Examples are provided below.

As described in more detail below, retention 252 of relevant data can be performed by storing the retained data 109 in a storage device such as data store 107A.

In at least one embodiment, if the decision 205 is made not to retain 252 the data item, the data item may be deleted from sliding buffer 108. Deletion 209 of expiring network traffic data 114 may be performed on a continuous basis, as new network traffic data 114 is stored in step 203. In this way, at any given time, sliding buffer 108 contains (at most) the most recently captured network traffic data 114 up to the expiration period. In at least one embodiment, the expiration period is equal to or greater than the pre-event retention period; in this manner, if an event is detected at some arbitrary point of time, pre-event retention period data 114 (captured before the event and stored in buffer 108) will still be available in buffer 108 at the time of detection of the event.

In another embodiment, if the decision 205 is made not to retain 252 the data item, the data item may be aggregated, compressed, edited, or otherwise processed. Thus, some portion of such data 114 can be retained, or a summary of such data 114 can be retained. For example the system can save portions of packets, or summary information or other data derived the packets. More particularly, in at least one embodiment, packet headers can be retained, while the packet payload may be discarded. Alternatively, the system can retain metadata concerning the packets (such as their origin and/or destination, and/or the like), selected portions of the packet payloads (such as strings or interesting data), and/or analytics derived from the packets (for example, an examination of the network port, protocol, and payload might indicate that the packets are part of an Oracle database session). Thus, for example, some summary information may be stored for data items not flagged for retention, although such summary information presumably would take less storage space than it would take to retain the data items in their raw state. Other variations are possible. In general, packets that correspond to a triggering event are far less frequent than the overall network traffic, so that retaining metadata or other derived or partial information can save significant storage space over retaining all packets in full.

If monitoring is to continue 213, the method returns to step 202. Otherwise the method ends 299.

In this manner, the method of FIG. 2A provides a mechanism by which data 114 describing network traffic before and after an event can be made available for later analysis. In situations where the event is a problem, attack, or other issue, such data 114 can be very useful in troubleshooting, analyzing, and addressing issues.

Retained data 109 can be retained for any suitable length of time. In at least one embodiment, it is retained until a security expert or other individual or system has had an opportunity to review and analyze retained data 109 and has manually indicated that the data 109 should be deleted. In at least one embodiment, data 109 is automatically deleted after some period of time in which the data 109 is not used or accessed.

### Determining Relevance of Data

In the context of the system and method described herein, any suitable criterion or criteria can be used to determine whether a data item is relevant, and therefore (in some embodiments) whether it should be retained. In general, relevant data is that set of data that results from partitioning, by some selection criteria, raw input data (such as network traffic data) into information that is deemed to be potentially useful in investigating, analyzing, or otherwise considering actions performed via the network or data transmitted via the network. Data not deemed relevant may be labeled irrelevant. Such distinctions are used, in the context of the system described herein, to determine which data is to be retained and which is to be deleted, as well as to determine when such deletion should take place.

The system and method described herein are set forth in connection with network traffic analysis, in which case relevance can be determined with respect to a possible future forensic investigation into an incident that has taken place with respect to the electronic network. One skilled in the art will recognize, however, that the techniques described herein can be implemented in connection with other types of data and domains. In such embodiments, relevance can be determined according to any suitable criteria, such as for example a degree of interest in content.

The selection criteria for determining which data is relevant may be based on additional data from any source, including, for example, external triggers, internal heuristics, and/or the like.

In at least one embodiment, the determination of relevance is made with respect to raw network traffic data that may be recorded by a network traffic data monitor or other component or device. Additional data sources, if present, can give more understanding and context to the raw data and help to determine whether data is relevant or not. In at least one embodiment, data about the raw captured data, such as metadata, can be used, including, for example, geographic location, intended source or destination of the data, time of capture, type of instrument doing the observations, and/or the like. In at least one embodiment, decisions about relevance are made with respect to some trigger event, such as an alarm, emergency broadcast, detection that a particular user has logged in or transmitted data, and/or the like. Other types of data that can be used in determining relevance include analytics or other processed information; this can include, for example, analyst reports, condensed or correlated logging information, average or aggregated traffic data, and the amount of people stopped by police at a certain intersection. In addition, any other available information can be used, such as for example, data from sources such as web pages, database records, and sound recordings.

The determination of relevance can be made at any suitable time. In at least one embodiment, relevance of data is determined at the time the data is received or recorded. In another embodiment, relevance is determined at the time a trigger event is detected and a decision is to be made as to whether to retain, delete, or otherwise process data that has been temporarily stored. In yet another embodiment, relevance is determined at some other suitable time.

Decisions on relevance may be influenced by multiple types of input, in which case the selection criteria can have components for each of the possible causes. Conversely, some event triggers might only be possible in a specific set of circumstances and therefore the selection criteria can be appropriately restricted.

Decisions on what data to include as relevant or irrelevant can be fairly broad (or even completely inclusive) in some circumstances and very narrow (including the null set) in other circumstances.

In at least one embodiment, all network traffic data 114 falling within the pre-event and post-event retention periods is deemed relevant, and therefore retained.

In another embodiment, a data item is deemed relevant if it is associated with a particular origin or destination identified in an active trigger event. This determination may be performed, for example, by matching the IP address of the source and/or destination of the data item against the IP address of a node identified in the active trigger event.

In yet another embodiment, in addition to retaining network traffic data 114 for nodes identified in the trigger event, the system can also selectively retain network traffic data 114 for other nodes not identified in the trigger event. For example, a data item may be deemed relevant if it has a source and/or destination node that is a certain distance from a node identified in the trigger event, where distance is measured in terms of number of how many direct network connections (or “hops”) apart are the nodes. Two nodes can be considered directly connected to one another if they have had communication with one another during a specified time period, such as the retention period or some other time period. Alternatively, two nodes can be considered directly connected to one another based on any other suitable criterion, such as having at least a threshold number of communications with one another during a specified time period, or being part of the same local area network, or any other criterion or combination of criteria. Based on these direct connections, each node can be given a distance value with respect to each other node. Thus, according to one embodiment, for a given trigger event, network traffic data is retained for nodes that are no farther than some pre-defined distance value.

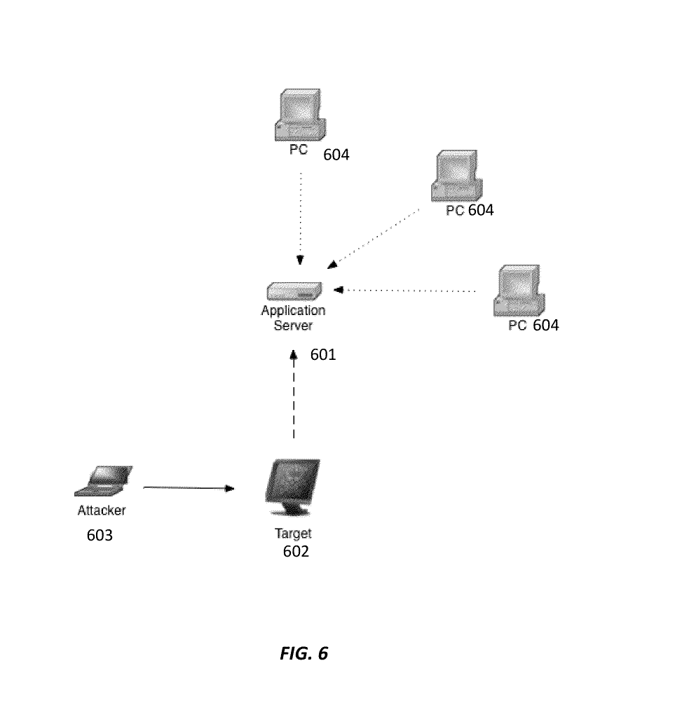

Referring now to FIG. 6, there is shown a block diagram depicting a scenario in which it is beneficial to store network traffic data for system components other than those directly targeted by an incoming attack, according to one embodiment. In the example of FIG. 6, a trigger event is detected in the form of an attack from attacker 603. One node 602 is identified as the target of the attack. In response to the trigger event, network traffic data items having time stamps within the retention period are retained if they are associated with attacker 603 and/or target 602. However, in this example, target 602 was communicating with application server 601 around the time of the attack, as indicated by the arrow with long dashed lines connecting target 602 and application server 601. In addition, three client PCs 604 were communicating with application server 601 around the time of the attack, as indicated by the arrows with short dashed lines connecting PCs 604 and application server 601.

In this example, application server 601 has a distance of one “hop” from target 602, and PCs 604 each have a distance of two “hops” from target 602. Thus, if the system is configured to retain network traffic data 114 for nodes up to one “hop” from the node identified in the trigger event, then the system would retain network traffic data items having time stamps within the retention period and having a source or destination of attacker 603, target 602, and/or application server 601. On the other hand, if the system is configured to retain network traffic data 114 for nodes up to two “hops” from the node identified in the trigger event, then the system would retain network traffic data items having time stamps within the retention period and having a source or destination of attacker 603, target 602, application server 601, and/or any of PCs 604.

In all of these cases, as described previously, the system retains network traffic data 114 (for the specified nodes) within the pre-event retention period as well as the post-event retention period for a trigger event.

In at least one embodiment, as described herein, relevant data can be stored in its raw, unmodified state, while other data (irrelevant data) can be deleted. Alternatively, irrelevant data can be retained in an aggregated, distilled, edited, or otherwise compressed form.

### Examples

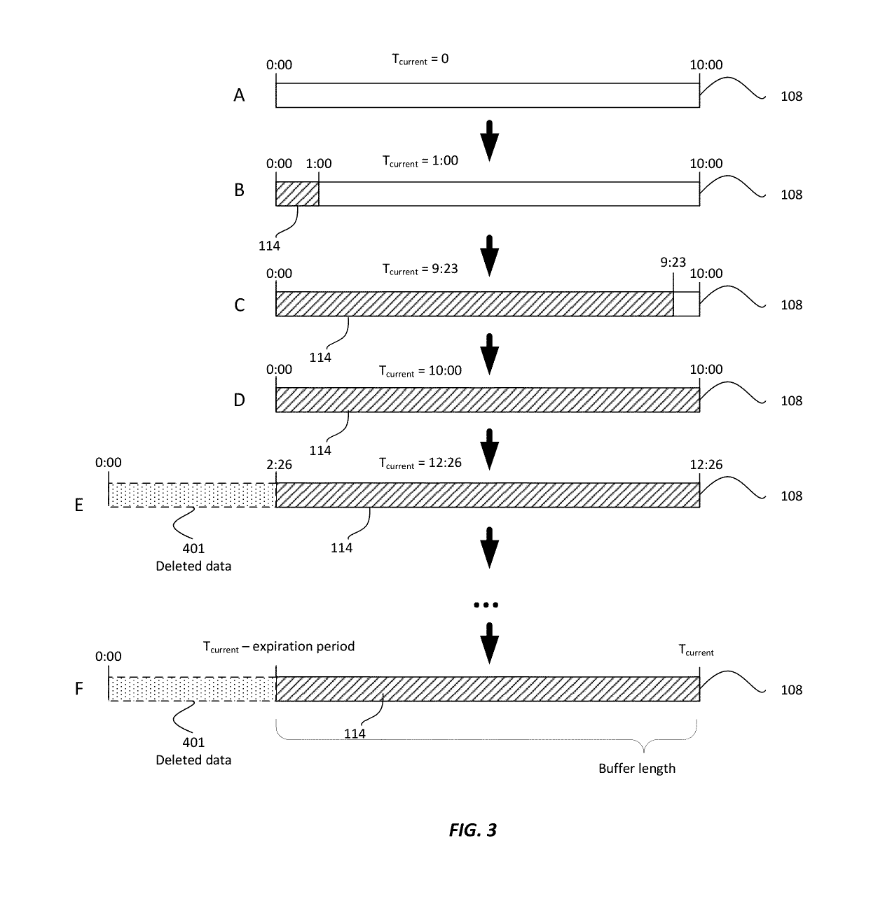

Referring now to FIG. 3, there is shown an example of operation of sliding buffer 108 for storing recent network traffic data 114, according to one embodiment. For illustrative purposes, the example of FIG. 3 assumes that no trigger events are detected. In the example, sliding buffer 108 has an expiration period of 10 minutes, so that stores the most recent 10 minutes of network traffic data 114; once more than 10 minutes of data 114 have been captured, older data 114 is deleted to make room for new data 114.

FIG. 3 depicts sliding buffer 108 at six different points in time, labeled A through F. For each point in time, the current time is indicated as T_{current}.

In A, T_{current} is zero, and buffer 108 is empty. No data 114 has been collected yet.

In B, T_{current} is 1:00 (one minute), and one minute of data 114 has been collected and stored in buffer 108.

In C, T_{current} is 9:23, and 9:23 of data 114 has been collected and stored in buffer 108.

In D, T_{current} is 10:00, and buffer 108 is now full. From this point on, when storing further data 114, data 114 that is older than the expiration period will be deleted or retained (or otherwise processed).

In E, T_{current} is 12:26. Buffer 108 contains the most recent ten minutes of data 114. Data 114 from time 0:00 through 2:26 has been deleted, since there were no active trigger events having a retention period that includes the time stamps of those data items. Deleted data 401 is shown in the Figure for illustrative purposes only.

F shows a general case at time=T_{current}. The expiration period (or buffer length) corresponds to the maximum amount of data that is stored in sliding buffer 108 at any given time. Thus, any data 114 that is older than the point in time indicated as T_{current}—expiration period has been deleted or retained (or otherwise processed), and is shown in the Figure (for illustrative purposes only) as deleted data 401.

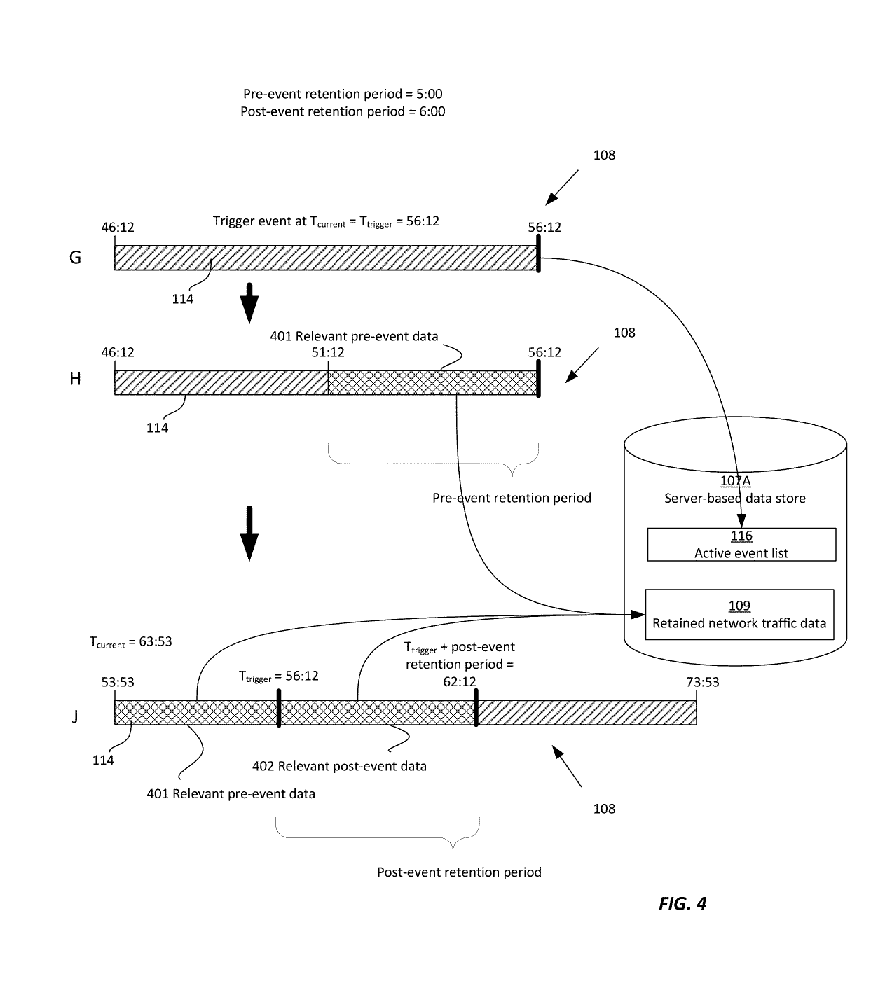

Referring now to FIG. 4, there is shown an example of selectively retaining data 114 from sliding buffer 108 in response to a trigger event, according to one embodiment. In this example, the pre-event retention period is five minutes, and the post-event retention period is six minutes. The expiration period for sliding buffer 108 is five minutes.

In the top part of FIG. 4 (labeled G), a trigger event is detected at T_{current}=T_{trigger}=56:12. The trigger event is recorded in active event list 116. As a result, as shown in H, relevant data having time stamps within the pre-event retention period (i.e., the five minutes preceding the trigger event, or 51:12 to 56:12) will be retained. Data having time stamps within this time period has an expiration time of 56:12 to 61:12. At the time of expiration of each data item in that time period, a determination is made that the detected trigger event's retention period includes the time stamp of the data item; therefore, if the data item is deemed relevant to the trigger event, the data item is retained (i.e., stored as retained network traffic data 109 in data store 107A or in some other location).

In addition, data having time stamps within the post-event retention period (i.e., the six minutes following the trigger event, or 56:12 to 62:12) will be retained as well. Data items having time stamps within this time period have an expiration time of 61:12 to 66:12. At the time of expiration of each data item in that time period, a determination is made that the detected trigger event's retention period includes the time stamp of the data item; therefore, if the data item is deemed relevant to the trigger event, the data item is retained (i.e., stored as retained network traffic data 109 in data store 107A or in some other location).

The bottom part of FIG. 4 (labeled J), depicts operation after some time has passed after the trigger event. Here, the current time T_{current}=73:53, which is several minutes after the trigger event time T_{trigger}=56:12, and after the trigger event has been removed from active event list 116. The diagram shows that, in addition to retaining relevant pre-event data 401, the system has also retained relevant post-event data 402, up to a time equal to T_{trigger}+the post-event retention period, which in this case is 56:12+6:00=62:12. At time 67:12, corresponding to the expiration time for the last data item having a time stamp (62:12) that falls within the retention period for the trigger event, the event is automatically removed from active event list 116, and normal operation is resumed where network traffic data 114 continues to be stored in sliding buffer 108 but is deleted after the expiration period (unless a subsequent event indicates that it should be retained).

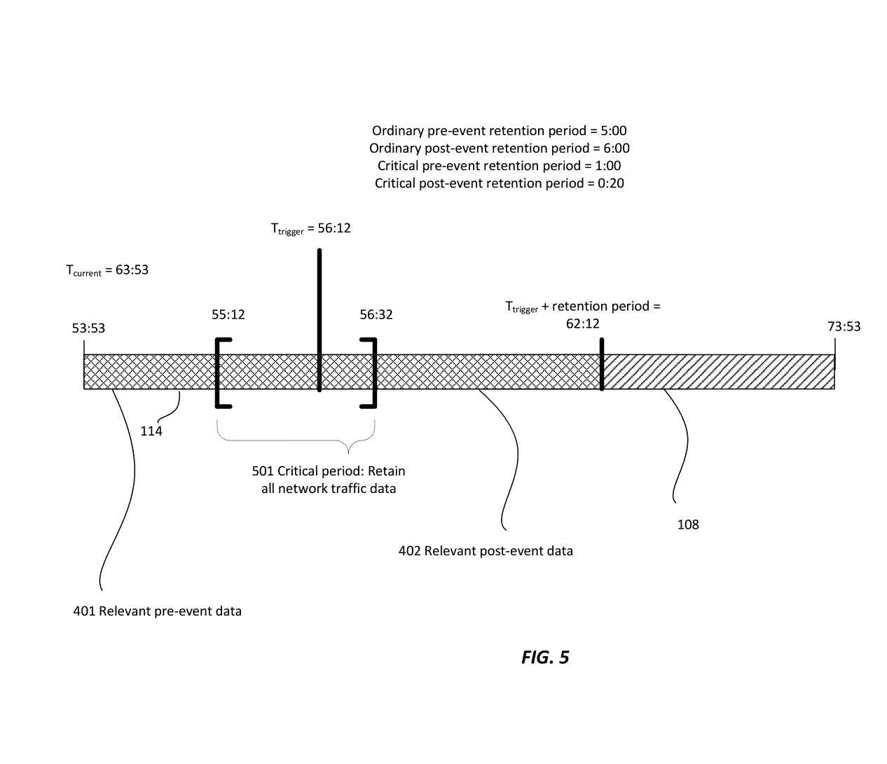

Referring now to FIG. 5, there is shown an embodiment in which two sets of retention periods are established: a critical pre- and post-event retention period 501 for which all network traffic data 114 is retained; and an ordinary pre- and post-event retention period for which network traffic data 114 deemed relevant to the event is retained. For clarity, FIG. 5, does not show pre-event data from time 51:12 to 53:53 that has already been deleted from sliding buffer 108 but was previously retained.

The time periods shown in the above-described examples are provided for illustrative purposes only. One skilled in the art will recognize that the system can be implemented using any suitable time periods, including those other than the depicted time periods.

### Alternative Embodiments

For illustrative purposes, the system is described herein in the context of network traffic analysis. However, the presently described techniques can be applied to other contexts. In general, the techniques described herein can be applied to any situation where an electronic, electromagnetic, visual, audio, textbased, or other physical phenomenon or signal is being recorded, wherein it may be advantageous to decide what recordings to retain after the fact, such as in response to some trigger event. Any suitable policy can be set forth to automatically determine which recordings to retain and which to delete in response to a trigger event.

The following are examples of such applications:

### Security Camera

Video and/or audio recordings can be made from any number of locations, with only the most recent N minutes being stored, for example in a sliding buffer. In response to a trigger event at a particular location, such as intrusion detection, recordings are retained based on a pre-event and post-event policy. For example, in response to a trigger event, data (such as video and/or audio streams) for the five minutes prior to the event, along with the six minutes after the event, can be retained. The retained data can be made available for further analysis, for example to ascertain the identity of the intruders and/or to track their location. Any form of metadata, scene analysis, audio analysis, alarm triggers, or the like, can be used to detect and identify trigger events such as intrusions.

### Digital Video Recorder (DVR)

The techniques described herein can be used for recording programming on a DVR or similar device. A policy can be established for keeping certain recordings (or parts of recordings), while deleting others. The policy can define a pre-event retention period and a post-event retention period. Continuous recording can be initiated for any number of channels or programs. Any suitable trigger event can be detected, causing the system to automatically retain recordings (or parts of recordings) relevant to the trigger event, while other recordings (or parts of recordings) can be deleted.

For example, the DVR can continuously record programs airing on a number of different stations. A trigger event such as a program, news item, or guest of interest can be detected on a particular station at a particular time. In response to detection of such an event, a portion of the recording of the program airing on that station, defined by the pre- and post-event retention period, is retained for future viewing. In this manner, the viewer can later view the few seconds leading up to the trigger event, followed by the event itself and its immediate aftermath.

Similar techniques can be used for other types of events, such as entertainment programming, news events, concerts, radio programming, sports programming, and/or the like. Any form of metadata, scene analysis, audio analysis, or the like, can be used to detect and identify trigger events such as goals or important news events.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for buffering and selectively retaining data in an electronic device, comprising:
receiving a stream of time-based data, comprising a plurality of data items having time stamps;
storing the received data items in a buffer;
detecting at least one trigger event, the trigger event being associated with a trigger event time;
for each detected trigger event, determining a retention period;
retaining at least a subset of the stored data items corresponding to time stamps falling within at least one determined retention period; and
storing the retained data in a storage device.

2. The computer-implemented method of claim 1, further comprising:
adding each detected trigger event to an active events list; and
automatically removing the trigger event from the active events list upon expiration of an event expiration period;
and wherein retaining at least a subset of the stored data items corresponding to time stamps falling within at least one determined retention period comprises:
determining whether the time stamp for each data item falls within the retention period for any trigger event in the active events list; and
responsive to the time stamp for a data item falling within the retention period for any trigger event in the active events list, retaining the data item.

3. The computer-implemented method of claim 1, wherein each retention period comprises:
a pre-event retention period representing a time period before the trigger event time; and
a post-event retention period representing a time period after the trigger event time.

4. The computer-implemented method of claim 1, further comprising establishing an expiration time for each data item stored in the buffer, and wherein retaining at least a subset of the stored data items corresponding to time stamps falling within at least one determined retention period comprises, at an expiration time for a data item stored in the buffer:
determining whether a trigger event has been detected having a retention period that includes the time stamp of the data item; and
responsive to a trigger event having been detected having a retention period that includes the time stamp of the data item, retaining the data item.

5. The computer-implemented method of claim 1, further comprising establishing an expiration time for each data item stored in the buffer, and wherein retaining at least a subset of the stored data items corresponding to time stamps falling within at least one determined retention period comprises, at an expiration time for a data item stored in the buffer:
determining whether a trigger event has been detected having a retention period that includes the time stamp of the data item;
responsive to a trigger event having been detected having a retention period that includes the time stamp of the data item, determining whether the data item is relevant to the trigger event, based on at least one criterion; and
responsive to a determination that the data item is relevant to the trigger event, retaining the data item.

6. The computer-implemented method of claim 1, further comprising deleting unretained data items from the buffer after a pre-defined expiration period has passed since the time stamps of the data items.

7. The computer-implemented method of claim 6, wherein:
storing the receiving time-based data items in a buffer is performed continuously; and
deleting unretained data items from the buffer is performed continuously.

8. The computer-implemented method of claim 6, further comprising, prior to deleting the unretained data items:
generating derived data from the unretained data items; and
storing the derived data in a storage device.

9. The computer-implemented method of claim 6, further comprising, prior to deleting the unretained data items:
summarizing the unretained data items to generate a summary; and
storing the summary in a storage device.

10. The computer-implemented method of claim 6, further comprising, prior to deleting the unretained data items:
aggregating the unretained data items to generate aggregated data; and
storing the aggregated data in a storage device.

11. The computer-implemented method of claim 6, further comprising, prior to deleting the unretained data items, storing a subset of the unretained data items in a storage device.

12. The computer-implemented method of claim 6, wherein the data items represent packets being transmitted in an electronic communications network, each packet comprising a header and a payload, the method further comprising, for at least one packet, prior to deleting the unretained data items:
storing, in a storage device, at least a subset of the headers for the packet.

13. The computer-implemented method of claim 1, wherein:
the time-based data comprises traffic data for an electronic communications network comprising a plurality of nodes; and
the trigger event comprises an event associated with the electronic communications network.

14. The computer-implemented method of claim 13, wherein the trigger event comprises an intrusion.

15. The computer-implemented method of claim 13, wherein the data items represent packets, each packet comprising at least a portion of a communication from one node to another node.

16. The computer-implemented method of claim 15, wherein retaining at least a subset of the stored data items corresponding to time stamps falling within at least one determined retention period comprises retaining data items representing packets associated with any communications within the network and having time stamps falling within at least one determined retention period.

17. The computer-implemented method of claim 15, wherein:
each packet is associated with a source node and a destination node;
the detected trigger event is associated with a target node of the network; and
retaining at least a subset of the stored data items corresponding to time stamps falling within at least one determined retention period comprises retaining data items representing packets associated with the target node and having time stamps falling within at least one determined retention period.

18. The computer-implemented method of claim 15, further comprising, for each detected trigger event, determining a critical retention period;
wherein:
each packet is associated with a source node and a destination node;
the detected trigger event is associated with a target node of the network; and
retaining at least a subset of the stored data items corresponding to time stamps falling within at least one determined retention period comprises:
retaining data items representing packets associated with the target node and having time stamps falling within at least one determined retention period; and
retaining additional data items representing packets associated with any communications within the network and having time stamps falling within at least one determined critical retention period.

19. The computer-implemented method of claim 15, wherein:
each packet is associated with a source node and a destination node;
the detected trigger event is associated with a plurality of target nodes of the network; and
retaining at least a subset of the stored data items corresponding to time stamps falling within at least one determined retention period comprises retaining data items representing packets associated with at least one of the target nodes in the plurality of target nodes and having time stamps falling within at least one determined retention period.

20. The computer-implemented method of claim 15, further comprising establishing a maximum network distance for retaining relevant data;
wherein:
each packet is associated with a source node and a destination node;
the detected trigger event is associated with a target node of the network; and
retaining at least a subset of the stored data items corresponding to time stamps falling within at least one determined retention period comprises:
retaining data items representing packets associated with the target node and having time stamps falling within at least one determined retention period; and
retaining data items representing packets associated with a node having a network distance from the target node that does not exceed the maximum network distance for retaining relevant data and having time stamps falling within at least one determined retention period.

21. The computer-implemented method of claim 15, further comprising:
establishing a maximum network distance for retaining relevant data; and
for each detected trigger event, determining a critical retention period;
wherein:
each packet is associated with a source node and a destination node;
the detected trigger event is associated with a target node of the network; and
retaining at least a subset of the stored data items corresponding to time stamps falling within at least one determined retention period comprises:
retaining data items representing packets associated with at least one of the target nodes in the plurality of target nodes and having time stamps falling within at least one determined retention period;
retaining data items representing packets associated with a node having a network distance from the target node that does not exceed the maximum network distance for retaining relevant data and having time stamps falling within at least one determined retention period; and
retaining additional data items representing packets associated with any communications within the network and having time stamps falling within at least one determined critical retention period.

22. The computer-implemented method of claim 1, wherein retaining at least a subset of the stored data items corresponding to time stamps falling within at least one determined retention period comprises:
designating at least a subset of the stored data items as relevant to the trigger event, based on at least one criterion; and
retaining those stored data items designated as relevant to the trigger event and falling within at least one determined retention period.

23. The computer-implemented method of claim 22, wherein:
the time-based data comprises traffic data for an electronic communications network comprising a plurality of nodes; and
the trigger event comprises an event associated with the electronic communications network;
and wherein designating at least a subset of the stored data items as relevant to the trigger event comprises:
determining whether each stored data item is associated with a node that is associated with the trigger event; and
responsive to a data item being associated with a node that is associated with the trigger event, designating the data item as relevant.

24. The computer-implemented method of claim 1, further comprising outputting the retained data for analysis of the trigger event.

25. The computer-implemented method of claim 1, wherein retaining at least a subset of the stored data items corresponding to time stamps falling within at least one determined retention period comprises copying stored data items from the buffer to the storage device.

26. The computer-implemented method of claim 1, wherein designating at least a subset of the stored data as relevant comprises designating at least a subset of the stored data as potentially of interest in connection with a forensic investigation concerning the trigger event.

27. A non-transitory computer-readable medium for buffering and selectively retaining data in an electronic device, comprising instructions stored thereon, that when executed on a processor, perform the steps of:
receiving a stream of time-based data, comprising a plurality of data items having time stamps;
storing the received data items in a buffer;
detecting at least one trigger event, the trigger event being associated with a trigger event time;
for each detected trigger event, determining a retention period;
retaining at least a subset of the stored data items corresponding to time stamps falling within at least one determined retention period; and
storing the retained data in a storage device.

28. The non-transitory computer-readable medium of claim 27, further comprising instructions stored thereon, that when executed on a processor, perform the steps of:
adding each detected trigger event to an active events list; and
automatically removing the trigger event from the active events list upon expiration of an event expiration period;
and wherein retaining at least a subset of the stored data items corresponding to time stamps falling within at least one determined retention period comprises:
determining whether the time stamp for each data item falls within the retention period for any trigger event in the active events list; and
responsive to the time stamp for a data item falling within the retention period for any trigger event in the active events list, retaining the data item.

29. The non-transitory computer-readable medium of claim 27, wherein each retention period comprises:
a pre-event retention period representing a time period before the trigger event time; and
a post-event retention period representing a time period after the trigger event time.

30. The non-transitory computer-readable medium of claim 27, further comprising instructions stored thereon, that when executed on a processor, perform the step of:
establishing an expiration time for each data item stored in the buffer;
and wherein retaining at least a subset of the stored data items corresponding to time stamps falling within at least one determined retention period comprises, at an expiration time for a data item stored in the buffer:
determining whether a trigger event has been detected having a retention period that includes the time stamp of the data item; and
responsive to a trigger event having been detected having a retention period that includes the time stamp of the data item, retaining the data item.

31. The non-transitory computer-readable medium of claim 27, further comprising instructions stored thereon, that when executed on a processor, perform the step of:
establishing an expiration time for each data item stored in the buffer;
and wherein retaining at least a subset of the stored data items corresponding to time stamps falling within at least one determined retention period comprises, at an expiration time for a data item stored in the buffer:
determining whether a trigger event has been detected having a retention period that includes the time stamp of the data item;
responsive to a trigger event having been detected having a retention period that includes the time stamp of the data item, determining whether the data item is relevant to the trigger event, based on at least one criterion; and
responsive to a determination that the data item is relevant to the trigger event, retaining the data item.

32. The non-transitory computer-readable medium of claim 27, further comprising instructions stored thereon, that when executed on a processor, perform the step of deleting unretained data items from the buffer after a pre-defined expiration period has passed since the time stamps of the data items.

33. The non-transitory computer-readable medium of claim 32, further comprising instructions stored thereon, that when executed on a processor, perform at least one selected from the group consisting of, prior to deleting the unretained data items:
generating derived data from the unretained data items and storing the derived data in a storage device;
summarizing the unretained data items to generate a summary, and storing the summary in a storage device;
aggregating the unretained data items to generate aggregated data, and storing the aggregated data in a storage device; and
storing a subset of the unretained data items in a storage device.

34. The non-transitory computer-readable medium of claim 32, wherein the data items represent packets being transmitted in an electronic communications network, each packet comprising a header and a payload, the non-transitory computer-readable medium further comprising instructions stored thereon, that when executed on a processor perform the step of, for at least one packet, prior to deleting the unretained data items:
storing, in a storage device, at least a subset of the headers for the packet.

35. The non-transitory computer-readable medium of claim 27, wherein:
the time-based data comprises traffic data for an electronic communications network comprising a plurality of nodes; and
the trigger event comprises an event associated with the electronic communications network.

36. The non-transitory computer-readable medium of claim 35, wherein the data items represent packets, each packet comprising at least a portion of a communication from one node to another node, and wherein retaining at least a subset of the stored data items corresponding to time stamps falling within at least one determined retention period comprises retaining data items representing packets associated with any communications within the network and having time stamps falling within at least one determined retention period.

37. The non-transitory computer-readable medium of claim 35, wherein the data items represent packets, each packet comprising at least a portion of a communication from one node to another node, and wherein:
each packet is associated with a source node and a destination node;
the detected trigger event is associated with a target node of the network; and
retaining at least a subset of the stored data items corresponding to time stamps falling within at least one determined retention period comprises retaining data items representing packets associated with the target node and having time stamps falling within at least one determined retention period.

38. The non-transitory computer-readable medium of claim 35, wherein the data items represent packets, each packet comprising at least a portion of a communication from one node to another node, and wherein:
each packet is associated with a source node and a destination node;
the detected trigger event is associated with a plurality of target nodes of the network; and
retaining at least a subset of the stored data items corresponding to time stamps falling within at least one determined retention period comprises retaining data items representing packets associated with at least one of the target nodes in the plurality of target nodes and having time stamps falling within at least one determined retention period.

39. The non-transitory computer-readable medium of claim 35, wherein the data items represent packets, each packet comprising at least a portion of a communication from one node to another node, and further comprising instructions stored thereon, that when executed on a processor, perform the step of establishing a maximum network distance for retaining relevant data;
wherein:
each packet is associated with a source node and a destination node;
the detected trigger event is associated with a target node of the network; and
retaining at least a subset of the stored data items corresponding to time stamps falling within at least one determined retention period comprises:
retaining data items representing packets associated with the target node and having time stamps falling within at least one determined retention period; and
retaining data items representing packets associated with a node having a network distance from the target node that does not exceed the maximum network distance for retaining relevant data and having time stamps falling within at least one determined retention period.

40. The non-transitory computer-readable medium of claim 27, wherein retaining at least a subset of the stored data items corresponding to time stamps falling within at least one determined retention period comprises:
designating at least a subset of the stored data items as relevant to the trigger event, based on at least one criterion; and
retaining those stored data items designated as relevant to the trigger event and falling within at least one determined retention period.

41. A system for buffering and selectively retaining data in an electronic device, comprising:
a data monitor, configured to receive a stream of time-based data, comprising a plurality of data items having time stamps;
a buffer, communicatively coupled to the data monitor, configured to store the received data items;
an event detector, configured to detect at least one trigger event, the trigger event being associated with a trigger event time;
a processor, communicatively coupled to the event detector, configured to:
for each detected trigger event, determine a retention period; and
designate for retention at least a subset of the stored data items corresponding to time stamps falling within at least one determined retention period; and
a first data store, communicatively coupled to the processor and to the buffer, configured to store the data designated for retention.

42. The system of claim 41, further comprising:
a second data store, communicatively coupled to the event detector, configured to store the detected at least one trigger event in a list of active events, and further configured to automatically remove the at least one trigger event from the active events list upon expiration of an event expiration period;
and wherein the processor designating for retention at least a subset of the stored data items corresponding to time stamps falling within at least one determined retention period comprises:
determining whether the time stamp for each data item falls within the retention period for any trigger event in the active events list; and
responsive to the time stamp for a data item falling within the retention period for any trigger event in the active events list, designating the data item for retention.

43. The system of claim 41, wherein each retention period comprises:
a pre-event retention period representing a time period before the trigger event time; and
a post-event retention period representing a time period after the trigger event time.

44. The system of claim 41, wherein the processor is further configured to establish an expiration time for each data item stored in the buffer;
and wherein the processor designating for retention at least a subset of the stored data items corresponding to time stamps falling within at least one determined retention period comprises, at an expiration time for a data item stored in the buffer:
determining whether a trigger event has been detected having a retention period that includes the time stamp of the data item; and
responsive to a trigger event having been detected having a retention period that includes the time stamp of the data item, designating the data item for retention.

45. The system of claim 41, wherein the processor is further configured to establish an expiration time for each data item stored in the buffer;
and wherein the processor designating for retention at least a subset of the stored data items corresponding to time stamps falling within at least one determined retention period comprises, at an expiration time for a data item stored in the buffer:
determining whether a trigger event has been detected having a retention period that includes the time stamp of the data item;
responsive to a trigger event having been detected having a retention period that includes the time stamp of the data item, determining whether the data item is relevant to the trigger event, based on at least one criterion; and
responsive to a determination that the data item is relevant to the trigger event, designating the data item for retention.

46. The system of claim 41, wherein the buffer is configured to delete unretained data items after a pre-defined expiration period has passed since the time stamps of the data items.

47. The system of claim 46, wherein the processor is further configured to, prior to the buffer deleting the unretained data items, perform at least one selected from the group consisting of:
generate derived data from the unretained data items and cause the first data store to store the derived data;
summarize the unretained data items to generate a summary, and cause the first data store to store the summary;
aggregate the unretained data items to generate aggregated data, and cause the first data store to store the aggregated data; and
cause the first data store to store a subset of the unretained data items.

48. The system of claim 46, wherein the data items represent packets being transmitted in an electronic communications network, each packet comprising a header and a payload, and wherein:
the first data store is configured to, for at least one packet, prior to the buffer deleting the unretained data items, store at least a subset of the headers for the packet.

49. The system of claim 41, wherein:
the time-based data comprises traffic data for an electronic communications network comprising a plurality of nodes; and
the trigger event comprises an event associated with the electronic communications network.

50. The system of claim 49, wherein the data items represent packets, each packet comprising at least a portion of a communication from one node to another node, and wherein the processor designating for retention at least a subset of the stored data items corresponding to time stamps falling within at least one determined retention period comprises designating for retention data items representing packets associated with any communications within the network and having time stamps falling within at least one determined retention period.

51. The system of claim 49, wherein the data items represent packets, each packet comprising at least a portion of a communication from one node to another node, and wherein:
each packet is associated with a source node and a destination node;
the detected trigger event is associated with a target node of the network; and
the processor designating for retention at least a subset of the stored data items corresponding to time stamps falling within at least one determined retention period comprises designating for retention data items representing packets associated with the target node and having time stamps falling within at least one determined retention period.

52. The system of claim 49, wherein the data items represent packets, each packet comprising at least a portion of a communication from one node to another node, and wherein:
each packet is associated with a source node and a destination node;
the detected trigger event is associated with a plurality of target nodes of the network; and
the processor designating for retention at least a subset of the stored data items corresponding to time stamps falling within at least one determined retention period comprises designating for retention data items representing packets associated with at least one of the target nodes in the plurality of target nodes and having time stamps falling within at least one determined retention period.

53. The system of claim 49, wherein the data items represent packets, each packet comprising at least a portion of a communication from one node to another node, and wherein the processor is further configured to establish a maximum network distance for retaining relevant data;
wherein:
each packet is associated with a source node and a destination node;
the detected trigger event is associated with a target node of the network; and
the processor designating for retention at least a subset of the stored data items corresponding to time stamps falling within at least one determined retention period comprises:
designating for retention data items representing packets associated with the target node and having time stamps falling within at least one determined retention period; and
designating for retention data items representing packets associated with a node having a network distance from the target node that does not exceed the maximum network distance for retaining relevant data and having time stamps falling within at least one determined retention period.

54. The system of claim 41, wherein the processor designating for retention at least a subset of the stored data items corresponding to time stamps falling within at least one determined retention period comprises:
designating at least a subset of the stored data items as relevant to the trigger event, based on at least one criterion; and
designating for retention those stored data items designated as relevant to the trigger event and falling within at least one determined retention period.
